(19) United States
(12) Patent Application Publication
(10) Pub. No.: US 2004/0243693 A1
(43) Pub. Date: Dec. 2, 2004

(54) Inbound connector

(76) Inventors: Michael Beisiegel, Poughkeepsie, NY (US); Jean-Sebatien Michel Delfino, San Carlos, CA (US); Piotr Przybylski, San Carlos, CA (US)

Correspondence Address: David R Irvin, IBM Corp, T81/B503, PO Box 12195, Research Triangle Park, NC, 27709, US

(21) Appl. No.: 10/489,051

(22) PCT Filed: Jun. 24, 2002
(86) PCT No.: PCT/GB02/02865

(30) Foreign Application Priority Data
Sep. 10, 2001 (CA) 2357168

(51) Int. Cl. G06F 15/177

(52) U.S. Cl. 709/220

(57) ABSTRACT

The present invention discloses a computer server having a generic interface for interacting with a variety of middleware products and application programming interfaces. The proposed architecture of the interface is such that knowledge of existing middleware systems is not needed to develop or modify server applications.

### FIELD OF THE INVENTION

The present invention relates generally to the field of connecting servers and clients with a generic interface, and more particularly to providing a server with a uniform interface for interacting with a variety of middleware products and application programming interfaces.

### BACKGROUND OF THE INVENTION

It is often necessary for computers built on different types of hardware and operating under different types of software to communicate with each other. One such situation is where a client (i.e. an application program or a component thereof) needs to access a server to request processing or access to data.

Traditionally, software known as “middleware” has facilitated these interactions. A number of middleware products address the problem of connectivity to backend systems such as databases and transaction systems. These middleware products provide clients with a variety of programming models, interfaces and protocols to access the backend systems. In particular, the middleware will act as a conduit for the data, carrying information and requests from the client to the server and back. One problem with the use of middleware in this way is that middleware tends to be specific to a given server system. Thus, a client application (or components) written to deal with one type of middleware (connecting to a particular server type) may have to be modified or rewritten in order to connect with a different server type. A developer would need to know the details of each middleware product with which the client application will interact in order to write the code.

M. Radestock and S. Eisenbach in their paper “Component Coordination in Middleware Systems” presented at Middleware '98, describe a system called “traps”, wherein messages from one component to another may be intercepted, translated and then routed to the intended (or a different) component. While this paper does describe a container performing translations, and traps intercepting and rerouting messages, it requires that all outgoing messages be monitored by a central trapping system, which is resource intensive and impractical for mediating component interactions with middleware-based systems in a distributed environment.

Canadian Patent Application 2,232,626, filed by the assignee of the present invention, discloses a “common connector framework” to address this problem. A connector architecture isolates the developer of an application component from the complexity of the various middleware products, and provides client applications with outbound connectors and a uniform approach to access backend systems. This technology acts as a layer between the middleware and the client application. The client application or component can be written to produce output and receive input based on a single protocol (i.e. that protocol used by the common connector framework). Thus, from the perspective of the client application, it will not matter which server or which middleware it is interacting with. Instead, the client application needs to be written only once; to conform to the protocol used by the common connector framework. The common connector framework software will be responsible for defining an interface with the middleware, and translating incoming and outgoing data between the protocol used by the client application and that used by the middleware.

What the common connector framework described in Canadian Patent Application 2,232,626 does not do is address interaction difficulties on the server side of these transactions. In particular, when writing new server applications, a developer will need to know the details of the middleware with which the server interacts. This can increase the difficulty of developing new server applications. Furthermore, the server side of client-server transactions is more complex, as the server must provide additional services such as security and quality of service.

There is an additional concern affecting the server side. The development of business-to-business (B2B) interactions means that servers from one business may now have to interact not only with client applications, but also directly with other servers from different businesses. In a business-to-business environment, applications need to drive business-to-business interactions with other applications. Client business-to-business applications will communicate interactions with server business-to-business applications providing business-to-business services using a variety of protocols and middleware. As long as the interactions were strictly between clients and servers within the same organization, the interface with the server side was addressed by the middleware. However, once the servers in one company are required to communicate directly with servers in a different company (which may be using different hardware and software configurations), problems begin to arise. For example, not all businesses will use the same protocols. Thus, different middleware may be needed to communicate with each type of “partner” server. This increases complexity, and requires knowledge of the relevant type of middleware when developing new server applications.

What is needed is a method to define the interactions of a server system with its environment, whether in the form of client applications or other servers, so that knowledge of existing middleware systems is not needed to develop or modify server applications. It is therefore desirable to provide a connector architecture for the server side applications.

### DISCLOSURE OF THE INVENTION

The present invention relates to a system and method for providing a computer server having a generic interface for interacting with a variety of middleware products and application programming interfaces.

In one aspect of the present invention there is provided a computer system communicating with a communications network, the computer system having:

a) a component server providing services to one or more service components and one or more inbound connectors;

b) each of the service components providing application logic; and

c) the service components providing a set of interfaces to a plurality of computer systems, the set of interfaces independent of middleware hosted by the plurality of computer systems, said inbound connectors in communication with said communications network, said component server and said service components.

In another aspect of the present invention there is provided a method of establishing a service to communicate with a service component, the method comprising the steps of:

a) requesting the service;

b) if an instance of the service is available, utilizing said instance of the service; and

c) if an instance of the service is not available, creating an instance of said service.

In yet another aspect of the present invention there is provided a computer readable medium containing instructions for enabling a computer system to communicate with a communications network, the medium containing:

a) instructions for a component server to provide services to one or more service components and one or more inbound connectors;

b) each of the service components having instructions to provide application logic; and

c) the service components providing instruction to implement a set of interfaces to a plurality of computer systems , the set of interfaces independent of middleware hosted by the plurality of computer systems, said inbound connectors in communication with the communications network, the component server and the service components.

### BRIEF DESCRIPTION OF THE DRAWINGS

The invention will now be described, by way of example only, with reference to the accompanying drawings, in which:

FIG. 1 is a block diagram of a business-to-business system;

FIG. 2 is a block diagram of the components of a server;

FIG. 3 is a block diagram illustrating the stacking of inbound connectors on a server;

FIG. 4 is a schematic diagram of the components of an inbound connector as implemented on a server;

FIG. 5 is a flowchart illustrating the process of an inbound connector to establish a service; and

FIG. 6 is a flowchart illustrating the process of an inbound connector to service a request.

### DETAILED DESCRIPTION OF THE INVENTION

The present invention provides a system and method for simplifying the interactions between clients and servers, and between servers and servers, each communicating with each other over a network. This is achieved by providing an inbound connector that serves as a layer between middleware software and a server. An inbound connector provides server components with a set of interfaces that isolate them from the complexity of the protocols and middleware used to communicate with other business-to-business interactions, and allows them to communicate interactions in a uniform way. This makes it easier to develop new server-side applications, to interface with other servers using different types of middleware, and to interface with clients.

When an inbound interaction is transmitted to a server, the form of that interaction will be defined by the system that sent the transaction and the middleware layer through which it was transmitted. Consequently, this inbound interaction could take many forms. An inbound connector defines a uniform interface between a server and its environment so that server applications can effectively handle inbound interactions from a variety of sources without having to be written or modified to conform to the specific middleware defining the inbound interaction.

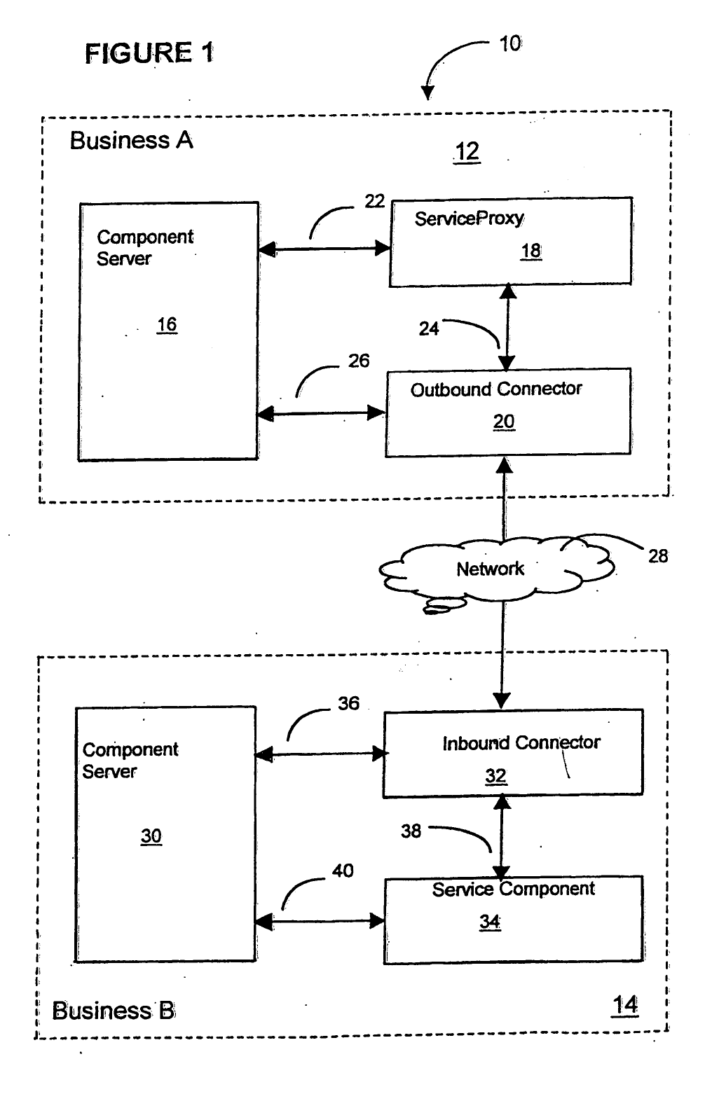

Referring now to FIG. 1, a block diagram of a business-to-business system utilizing the present invention is shown generally as 10. System 10 comprises a client 12 and a server 14. In the scenario of business-to-business communications, one may think of client 12 as “Business A” and server, 14 as “Business B”. In a typical interaction, client 12 requests information from server 14.

Client 12 comprises component server 16, ServiceProxy 18 and outbound connector 20. An application program (the “requester”), not shown, uses component server 16 to obtain information from server 14. The requester sends a request via interface 22 to ServiceProxy 18 (through component server 16), which reformats the request. The request is reformatted to hide the details such as the establishment of a connection with server 14 and the necessary communication protocol.

ServiceProxy 18 then forwards the request to outbound connector 20 via interface 24. Outbound connector 20 packages the request and through the use of the appropriate interface and communication protocol, sends the request to server 14 via network 28. When creating the request, outbound connector 20 may make use of general services such as data logging provided by component server 16 via interface 26.

At some point outbound connector 20 will receive a response to the request from server 14 via network 28. The response is then returned to ServiceProxy 18 via interface 24. ServiceProxy 18 then returns the result to the requestor via interface 22. Server 14 comprises component server 30, inbound connector 32 and service component 34.

Component server 30 is similar to component server 16 in that it provides services to applications. However, in this scenario they are not requesting applications (i.e. requesters) but rather applications that provide data to the requesters.

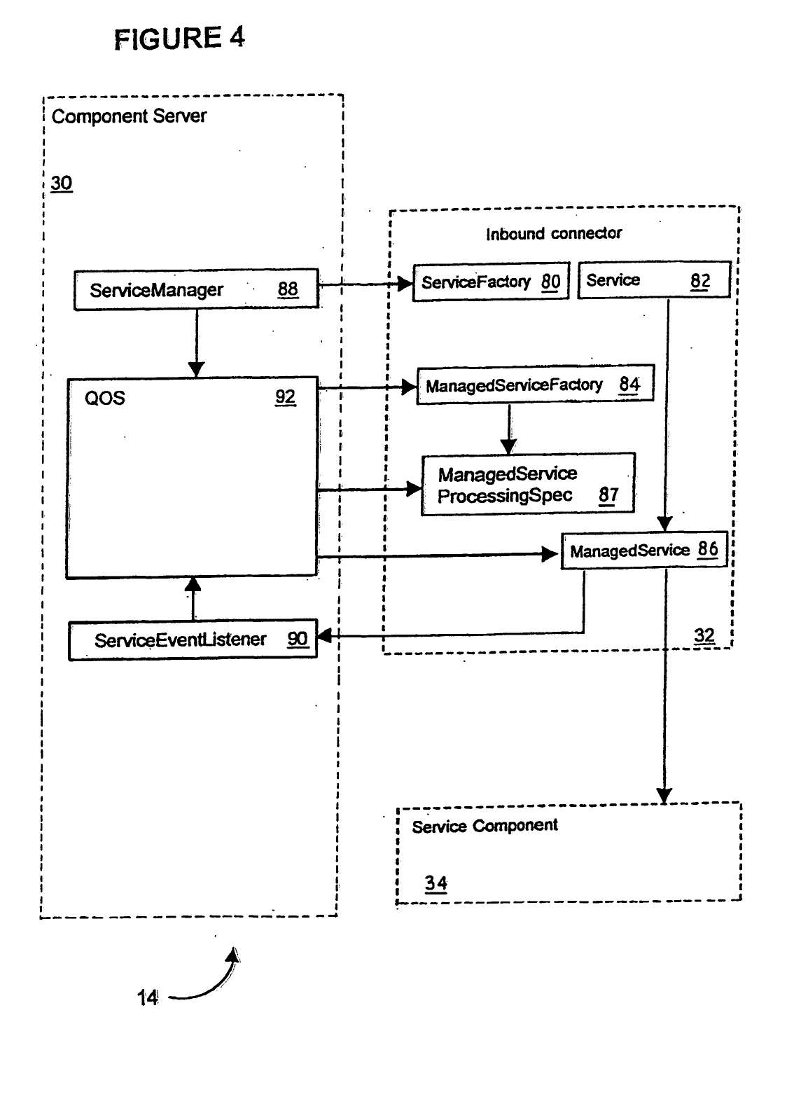

Inbound connector 32 receives a request from outbound connector 20 via network 28. Inbound connector 32 then examines the request to determine what information server 14 needs to provide. In some cases the request from connector 20 may require that quality of service (QOS) data be provided. If this is the case such a request is passed to component server 30 via interface 36 for processing. The term QOS is widely used in the industry and has taken on a variety of definitions. In the present invention the inventors mean QOS to stand for services provided by QOS 92 of component server 30 (see FIG. 4). Two such examples are:

a) security, in this case QOS 92 ensures that only those permitted to access data may do so; and

b) logging of transactions, in this case should a failure or security breach occur, QOS 92 provides trace data

These two examples are not meant to be an exhaustive list, merely an indication of the type of services that may be provided by QOS 92 of the present invention.

Inbound connector 32 then passes information regarding, the required data to a specific service component 34, capable of providing,the data, via interface 38. Service component 34 may make use of the services provided by component server 30, using interface 40, in order to satisfy the request.

The results of the request are returned by service component 34 to inbound connector 32 and reformatted for transport to connector 20 via network 28.

Inbound connector 32 disclosed herein provides a well-defined and consistent interface 38 for service components 34. Interface 38 of the present invention hides the complexity of the middleware and application programming interfaces (APIs) used to permit communication. Specifically, service components 34 do not need to interface with various APIs of different middleware programs. Instead, service components 34 can implement the same interface calls to get a request from a client, execute the request, and return a response regardless of the platform or software used by the client.

Interface 36 allows inbound connector 32 to use infrastructure services such as error handling, trace logging, security controls or remote access services (RAS) provided by component server 30. A similar structure is used for component server 16 with interface 26.

Both inbound connector 32 and outbound connector 20 are distinct entities, and both are needed if a given server is to operate as both a client and a server (i.e. in different roles depending on the circumstances). This is because there are different APIs for outbound and inbound interactions, and most protocols do not permit communications resources to be reused (although some, such as MQSeries as provided by International Business Machines Corporation and Java Message Service as provided by Sun Microsystems, do permit this). *MQSeries is a trademark of International Business Machines Corporation and Java is a trademark of Sun Microsystems. Thus, if a particular system is to function only as a client, then only outbound connector 20 is needed, and if it is to function only as a server, only inbound connector 32 is required. If a system is to function as both a client and a server, however, it should have both outbound connector 20 and inbound connector 32.

Interface 24 on client 12 and interface 38 on server 14 are preferably identical. More particularly, the same interface in terms of the methods to be invoked, and elements to be passed and returned, should preferably be used for interfaces 24 and 38, even though implementation of this interface on client 12 may be different from implementation on server 14. If interfaces 24, 38 are identical, then network 28 becomes transparent and ServiceProxy 18 can be developed as though it were calling service component 34 directly. If, on the other hand, interface 38 on server 14 is different from interface 24 on client 12, then client applications must deal with these differences, which increases complexity and makes it more difficult to develop and modify client applications. However, advantages of using inbound connector 32 to the development and modification of applications for server 14 will be present regardless of whether the same interface as that in interface 38 on server 14 is used for interface 24 on client 12, and will be present even if no outbound connector 20 is used at all on client 12.

The architecture permits implementations of inbound connector 32 to be independent of the platform they run on, since they can request services from component server 30 by using a well-defined set of system contract interfaces through interface 36. Similarly, there is no need for component server 30 to be concerned with the details of a particular inbound connector implementation 32, as component server 30 can provide generic services (such as connection and transaction management) that can be used by any inbound connector 32. Interfaces 36, 40 are identical between component server 30 and inbound connector 32, and between component server 30 and service component 34.

An inbound connector 32 is made up of a set of classes that implement interfaces 36, 38 and make use of any necessary middleware and APIs to permit communication with other applications using a particular protocol. Although implementation of a connector 32 is different for each type of middleware or protocol, interfaces 36, 38 remain the same. It is this feature that isolates service components 34 from the complexity of middleware and APIs, and therefore significantly simplifies development and modification of server applications.

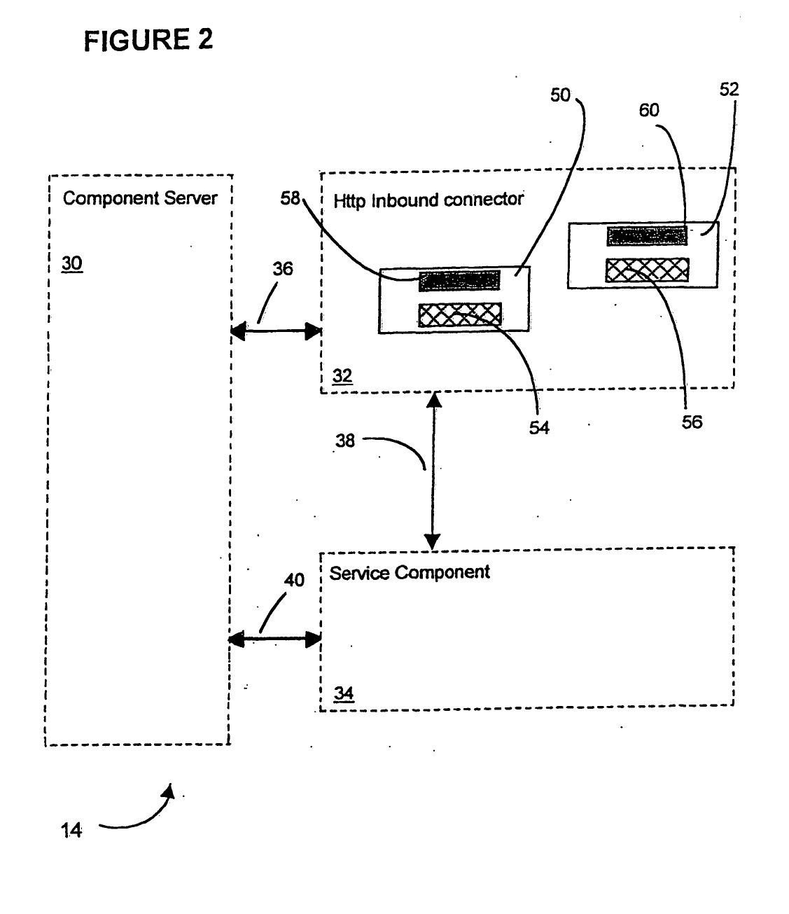

Referring now to FIG. 2, a block diagram of the components of a server is shown generally as 14. As described with regard to FIG. 1, server 14 comprises component server 30, inbound connector 32 and service component 34.

Communication protocols used in business-to-business applications use what are referred to generically in the Simple Object Access Protocol (SOAP) context as “envelopes” and “payloads” represented in Extended Markup Language (XML) to communicate interactions. More particularly, XML communications as illustrated in FIG. 2 take the form of request envelope 50 (the incoming communication from client 12 to server 14 ) and response envelope 52 (the outgoing communication from server 14 to client 12 ). Request envelope 50 contains request payload 54, and response envelope 52 contains response payload 56. Both request envelope 50 and response envelope 52 contain protocol specific information as well as quality of service (QOS) elements 58, 60 respectively, while request payload 54 and response payload 56 contain application data. Quality of service elements 58, 60 will typically include security information, as well as context and resource coordination elements. QOS elements 58 need to be processed on component server 30 before application data can be passed to service component 34.

Inbound connector 32 is responsible for extracting QOS elements 58 from request envelope 50 and performing any required processing, which typically involves component server 30. Inbound connector 32 is able to implement this processing in a manner that is platform independent since it uses well-defined interface 36 to invoke services from the component server 30.

The use of inbound connector 32 where a request is sent from client 12 using HTTP (HyperText Transfer Protocol) is described. Inbound connector 32 implements HTTP, allowing client 12 and server 14 to implement business-to-business applications using HTTP as a communication protocol. Component server 30 provides the runtime environment required by service component 34 (e.g. Java Virtual Machine for a Java service component 34 ) and infrastructure services, while inbound connector 32 handles communication with client applications and processing of QOS elements 58 through interface 36 to component server 30. Service component 34 provides a business function (carried out as application logic) that needs to be exposed as a service.

The flow of information on server 14 is described as follows. A service request from a client 12, comprising request envelope 50, is sent using HTTP and received by inbound connector 32. Inbound connector 32 receives request envelope 50 and extracts QOS elements 58 and request payload 54. Inbound connector 32 then processes QOS elements 58 extracted from request envelope 50. Specifically, inbound connector 32 uses interface 36 to request services from component server 30, such as setting up a security context or starting a transaction. Inbound connector 32 then uses interface 38 to pass application data contained in request payload 54 to service component 34. Service component 34 receives the application data contained in request payload 54 and executes any required application logic. During processing of application data contained in request payload 54, service component 34 can also make use of infrastructure services from component server 30 through interface 40. Typically, service component 34 will use a security context or a resource coordination context set by inbound connector 32 when it processed QOS elements 58. Service component 34 returns a response through interface 38 to inbound connector 32, which packages the response as response payload 56. Inbound connector 32 obtains any necessary QOS elements 60 from component server 30 through interface 36 and then packages these QOS elements 60 along with response payload 56 in response envelope 52. There may be no need for QOS elements 60 in a response envelope 52. If QOS elements are needed they may typically be security or transaction information. Response envelope 52 is then returned to client 12.

In the preferred embodiment, a business-to-business application could provide the same set of services to clients using HTTP, and to messaging applications using a messaging middleware such as MQSeries as provided by International Business Machines Corp. To accommodate these various protocols and middleware products, the architecture of inbound connector 32 allows inbound connectors to be stacked to implement the same interface 38 on top of different transport protocols.

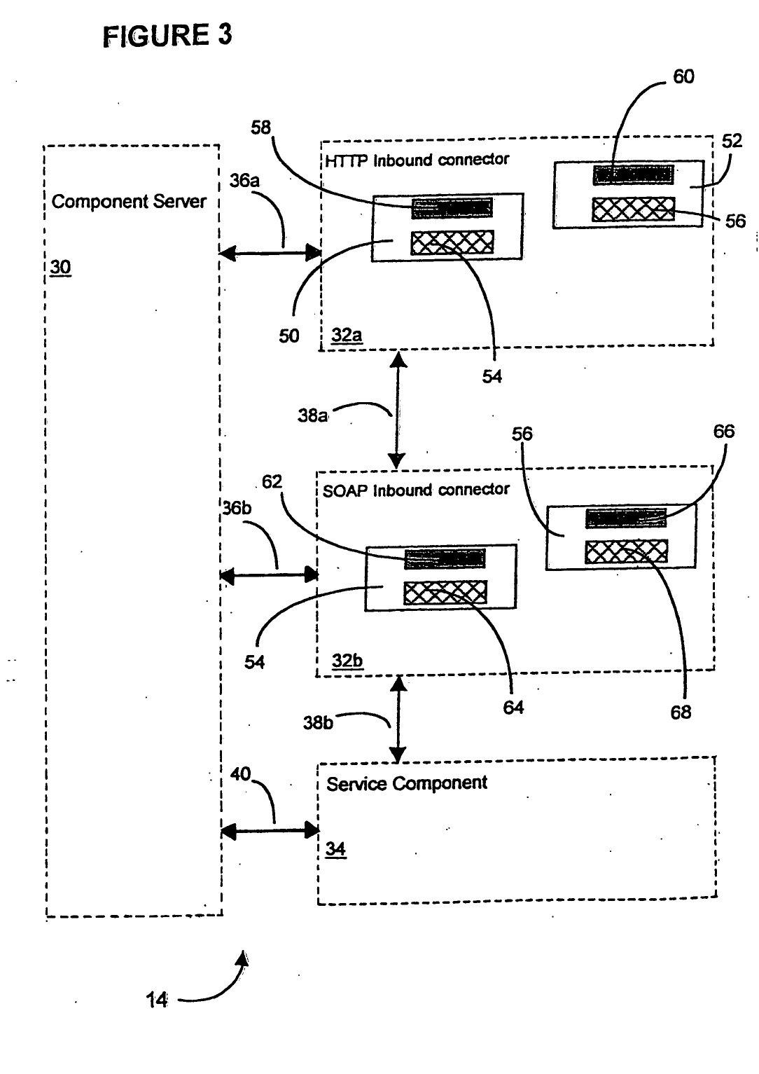

FIG. 3 is a block diagram illustrating the stacking of inbound connectors 32 on a server 14. In particular, FIG. 3 shows the use of inbound connectors 32 to implement the Simple Object Access Protocol (SOAP) over HTTP. HTTP is a transport protocol, while SOAP is a higher-level protocol used in business-to-business exchanges and which can be used over various transport protocols such as HTTP, SMTP (Simple Mail Transfer Protocol) or JMS (Java Message Service) as provided by Sun Microsystems.

Server 14 may contain a plurality of inbound connectors 32, each handling a different type of communication protocol. In particular, inbound connectors 32 may be layered so that an inbound connector 32 implementing one protocol may pass a request to another inbound connector 32 implementing a different protocol.

As shown in FIG. 3, inbound connector 32a implements HTTP while inbound connector 32b implements SOAP. Thus, in FIG. 3, HTTP request payload 54 is actually SOAP request envelope 54. When server 14 receives a request, inbound connector 32a is responsible for opening HTTP request envelope 50, processing corresponding QOS elements 58, and then passing request payload 54 (SOAP request envelope 54) to next inbound connector 32b via interface 38a. Inbound connector 32b receives HTTP payload 54 (SOAP request envelope 54) and is responsible for opening SOAP request envelope 54, processing corresponding QOS elements 62 and then passing SOAP request payload 64 found in SOAP request envelope 54 to the next inbound connector 32 (if any). If, as in FIG. 3, inbound connector 32b is lowest in a stack of inbound connectors 32, it will extract SOAP request payload 64 and pass it directly to service component 34. It will be appreciated by one skilled in the art that inbound connectors 32 could conform to any protocol, and that any number of inbound connectors may be stacked without departing from the present invention.

The logical flow of the functionality illustrated in FIG. 3 when a service request is sent to server 14 using SOAP over HTTP is as follows. HTTP inbound connector 32a receives a service request in HTTP in the form of HTTP request envelope 50. HTTP inbound connector 32a then extracts QOS elements 58 and HTTP request payload 54 (SOAP request envelope 54) from HTTP request envelope 50. HTTP inbound connector 32a uses interface 36a to process extracted QOS elements 58. HTTP inbound connector 32a then uses interface 38a to pass HTTP request payload 54 (SOAP request envelope 54) to SOAP inbound connector 32b. SOAP inbound connector 32b extracts SOAP-specific QOS elements 62 and processes them, using interface 36b. Inbound connector 32b then extracts SOAP request payload 64 and passes it to service component 34, which executes any required application logic. Service component 34 then returns a response through interface 38b to SOAP inbound connector 32b. SOAP inbound connector 32b then uses interface 36b to obtain any necessary QOS elements 66 and packages them with SOAP response payload 68 inside SOAP response envelope 56. SOAP response envelope 56 is then returned to HTTP inbound connector 32a where it is placed in HTTP response envelope 52 as HTTP response payload 56. HTTP inbound connector 32a then uses interface 36a to add QOS elements 60 to HTTP response envelope 52 and then sends HTTP response envelope 52 back to the client 12 using HTTP.

The interface 38a between HTTP inbound connector 32a and SOAP inbound connector 32b is identical to the interface 38b between SOAP inbound connector 32b and service component 34. This is what gives the use of inbound connectors their flexibility. One can use different inbound connectors, layered if necessary, depending on which protocols are being used, and the interaction will ultimately be passed to service component 34 using the same interface 38 no matter which protocols were used in transmission.

FIG. 4 is a schematic diagram of the components of an inbound connector 32 as implemented on a server 14. The implementation of inbound connector 32 comprises the following classes and associated interfaces: ServiceFactory 80, Service 82, ManagedServiceFactory 84, ManagedService 86 and ManagedServiceProcessingSpec 87. In addition, component server 30 implements the classes of ServiceManager 88, ServiceEventListener 90 as well as QOS services 92. There also exists ServiceException (not shown in FIG. 4), which is an exception class used to report errors (using the Java exception mechanism). These classes together form what the inventors refer to as “a processing core”.

ServiceFactory class 80 represents objects capable of creating instances of Service 82. However, ServiceFactory 80 does not keep a reference to an instance of Service 82. ServiceFactory 80 works with ServiceManager 88 to allocate and control pools of handles to physical connections to clients 12. More particularly, an instance of ServiceFactory 80 holds a reference to ServiceManager 88 and is associated with a ManagedServiceFactory 84. ServiceFactory 80 gets an instance of Service 82 by invoking the allocateservice method of ServiceManager 88 (described in greater detail below). The interface for ServiceFactory 80 is as follows:

public interface ServiceFactory extends java.io.Serializable {
Service getService( );
}

Service 82 represents a handle to a physical connection to a client 12. Instances of Service 82 are created by a ServiceFactory 80 by invoking the allocateService method of ServiceManager 88. An instance of Service 82 is associated with an instance of ManagedService 86. Service 82 is responsible for receiving an interaction request from client 12 and passing it to associated ManagedService 86 (which in turn will invoke target service component 34) and for sending a response from ManagedService 86. Service 82 has the following interface:

public interface Service{
public javax.resource.cci.Record execute(
javax.resource.cci.InteractionSpec interactionSpec,
javax.resource.cci.Record inputRecord)
throws javax.resource.ResourceException;
public Boolean execute(
javax.resource.cci.InteractionSpec interactionSpec,
javax.resource.cci.Record inputRecord,
javax.resource.cci.Record outputRecord)
throws javax.resource.ResourceException;
}

Service 82 is implemented by inbound connector 32 and by service component 34. The execute method of Service 82 executes an inbound connector interaction. ManagedService 86 calls the getInteractionSpec method of ManagedServiceProcessingSpec 87 to get an InteractionSpec. An InteractionSpec contains properties that specify the details of an interaction. The set of properties is connector specific. For example, an HTTP connector has HTTP specific properties such as type of content, header fields, verb (e.g. GET or POST). It is the contents of the InteractionSpec that allows an inbound connector 32 to select the appropriate service component 34. ManagedService 86 then passes the InteractionSpec to the execute method of Service 82. The inputRecord of the execute method of Service 82 contains interaction request data. On return from the execute method of Service 82, the outputRecord of the execute method contains any interaction response data. Service component 34 implements the execute method of Service 82 by performing appropriate application logic. By application logic the inventors mean the logic necessary to implement the execute method. Typically a developer will look at the InteractionSpec and the data input record to implement the requested functionality (e.g. query a database or update files). An inbound connector 32 implements the execute method of Service class 82 by delegating the interaction to the associated instance of ManagedService 86 in a connector-specific way (i.e. characteristic of the particular connector implementation in terms of call sequence, method names and other implementation factors). This structure permits the implementor of the inbound connector 32 to utilize the associated ManagedService 86 to best meet their needs.

ManagedServiceFactory 84 is a class capable of creating instances of ManagedService 86. The interface for ManagedServiceFactory 84 is as follows:

public interface ManagedServiceFactory extends java.io.Serializable {
ManagedService createManagedService( );
Object createServiceFactory( );
Object createServiceFactory(ServiceMananger serviceManager);
}

ManagedServiceFactory 84 represents objects capable of creating instances of ManagedService 86 as well as instances of ServiceFactory 80. However, ManagedServiceFactory 84 does not keep a reference to a created ManagedService 86. The createManagedService method of ManagedServiceFactory 84 creates an instance of ManagedService 86. The createServiceFactory method of ManagedServiceFactory 84 creates a new instance of ServiceFactory 80 associated with that instance of ManagedServiceFactory and passes an instance of the interface of ServiceManager 88 to created ServiceFactory 80.

ManagedService 86 represents a connection handle to a service component 34. Instances of ManagedService 86 are created by ManagedServiceFactory 84. ManagedService 86 can support multiple Services 82, although in the present implementation only one instance of Service 82 can interact with service component 34 at a time. As one skilled in the art will recognize the use of multiple threads and concurrent users is possible, however the inventors have chosen to not provide this functionality in the preferred embodiment. ManagedService 86 is responsible for extracting any QOS elements from an incoming request and notifying, component server 30 of any QOS requirements through ServiceEventListener 90. Component server 30 is responsible for creating any instances of QOS 92 to handle requests from ServiceEventListener 90. and then invoking ManagedServiceFactory 84 and ManagedService 86. ManagedServiceFactory 84 utilizes QOS 92 to establish a pool of instances of ManagedService 86. thus, if an instance of ManagedService 86 exists in the pool and meets the particular security or other transaction characteristics specified by QOS 92, that instance will be used. If no ManagedService 86 meets the requirements of QOS 92, a new instance of ManagedService 86 will be created by ManagedServiceFactory 84. ManagedService 86 uses the authenticate method of ServiceEventListener 90 to process any security specified in QOS 92. ManagedService 86 has the following interface:

public interface ManagedService {
void addServiceEventListener(ServiceEventListener serviceEventListener);
java.io.PrintWriter getLogWriter( );
java.lang.Object getService( );
void removeServiceEventListener(ServiceEventListener
serviceEventListener);
void setLogWriter(java.io.PrintWriter logWriter);
}

ManagedService 86 comprises objects responsible for handling interactions with service component 34. ManagedService 86 calls the getServiceFactory method of ManagedServiceProcessingSpec 87, which provides an instance of ServiceFactory 80 by calling the createServiceFactory method of ManagedServiceFactory 84. ManagedService 86 then calls the getservice method of ServiceFactory 80, which returns a new instance of Service 82. To invoke the execute method of Service 82 and pass the necessary information to target service component 34, ManagedService 86 requires inputRecord and outputRecord, and an InteractionSpec (containing connector-specific properties of an interaction). ManagedService 86 has inputRecord and outputRecord, and obtains InteractionSpec via the reference in ManagedServiceProcessingSpec 87. Once an InteractionSpec has been obtained, ManagedService 86 has all necessary data and can pass the data to service component 34 through the execute method of Service 82.

The addServiceEventListener method of ManagedService 86 is used by ServiceManager 88 to register a ServiceEventListener 90 with ManagedService 86. ManagedService 86 will notify all ServiceEventListeners 90 of any QOS-related events (for example if authentication is needed before an inbound interaction can be processed).

]ManagedServiceProcessingSpec 87 is a class used to hold references to an InteractionSpec and to ServiceFactory 80. ManagedServiceProcessingSpec class 87 has the following interface:

public interface ManagedServiceProcessingSpec extends java.io.
Serializable {
javax.resource.cci.InteractionSpec getInteractionSpec( );
com.ibm.service.cci.ServiceFactory getServiceFactory( );
void setInteractionSpec(javax.resource.cci.InteractionSpec
interactionSpec);
void setServiceFactory(com.ibm.service.cci.ServiceFactory
serviceFactory);
}

ManagedServiceProcessingSpec 87 is initialized by means selected by the implementor of the present invention. Typically this could be done via configuration or deployment descriptor.

ServiceManager 88 is a class that is implemented by component server 30 to support inbound connectors. ServiceManager 88 provides component server 30 with the ability to coordinate and control resources used by a Service 82. ServiceManager 88 has the following interface:

public interface ServiceManager extends java.io.Serializable {
java.lang.Object allocateService(ManagedServiceFactory
managedServiceFactory);
}

The allocateService method of ServiceManager 88 provides a way for inbound connector 32 to pass service allocation requests to component server 30. Component server 30 provides Quality of Service (QOS) 92 such as security, transaction management or logging for a service request, then delegates actual creation of an instance of Service 82 to ManagedServiceFactory 84.

ServiceEventListener 90 is a class implemented by component server 30 to support inbound connectors 32. ServiceEventListener 90 receives events from instances of ManagedService 86 and implements corresponding actions inside component server 30, such as setting up and handling of any required QOS 92. The interface of ServiceEventListener 90 is as follows:

public interface ServiceEventListener extends java.util.EventListener {
void authenticate (javax.security.auth.Subject subject)
throws com.ibm.service.ServiceException;
}

The interface of ServiceEventListener 90 allows it to receive QOS-related events from an instance of ManagedService 86. An instance of ServiceEventListener 90 is registered with a ManagedService 86 using the addServiceEventListener method of Managed Service 86. ManagedService 86 invokes the authenticate method of ServiceEventListener 90 to authenticate an inbound interaction before invoking the execute method of Service 82 and passing the interaction to the target service component 34.

The ServiceException class extends the Java exception class and is used to report inbound connector errors. The ServiceException class is potentially used at runtime by multiple classes and is not shown in FIG. 4. The interface of ServiceException class 91 is as follows:

public class ServiceException extends Exception {
public ServiceException();
public ServiceException(String s);
}

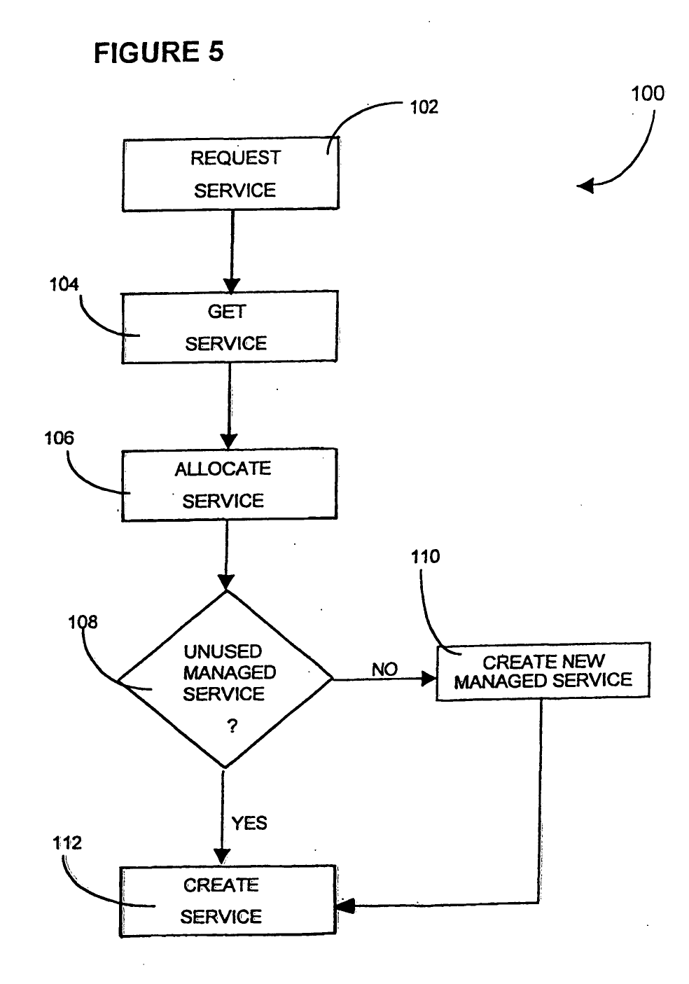

Referring now to FIG. 5, a flowchart illustrating the process of an inbound connector 32 to establish a service 82 is shown generally as 100.

Beginning at step 102 ManagedService 86 calls the getServiceFactory method of ManagedProcessingSpec 87, which creates an instance of ServiceFactory 80 by calling the createServiceFactory method of ManagedServiceFactory 84. At step 104, ManagedService 86 calls the getService method of ManagedServiceFactory 84. At step 106, ServiceFactory 80 invokes the allocateservice methodof ServiceManager 88. At step 108 a test is made to determine if there exists an unused instance of ManagedService 86 in the pool of such instances. If no instance exists, processing moves to step 110 where ManagedServiceFactory 84 creates a new instance of ManagedService 86 and processing moves to step 112. If the test at step 108 indicates that an instance exists then that instance is utilized and processing moves to step 112. At step 112 ManagedService 86 calls the getService method of ServiceFactory 80 to create a new instance of Service 82.

With regard to the pooling of Managed Services 86, ServiceManager 88 maintains a list of each ManagedService 86 that has been created, used and then released (i.e. they are no longer being used to service a request). Instead of discarding a ManagedService 86 when it is no longer needed, ServiceManager 88 stores and reuses it when necessary, thus reducing the need to create new instances of ManagedService 86, thereby improving efficiency of component server 30. It will be appreciated by one skilled in the art that the proposed architecture merely suggests the pooling but does not enforce it, leaving the decision of whether to enforce this pooling to the person who implements each ServiceManager class 88.

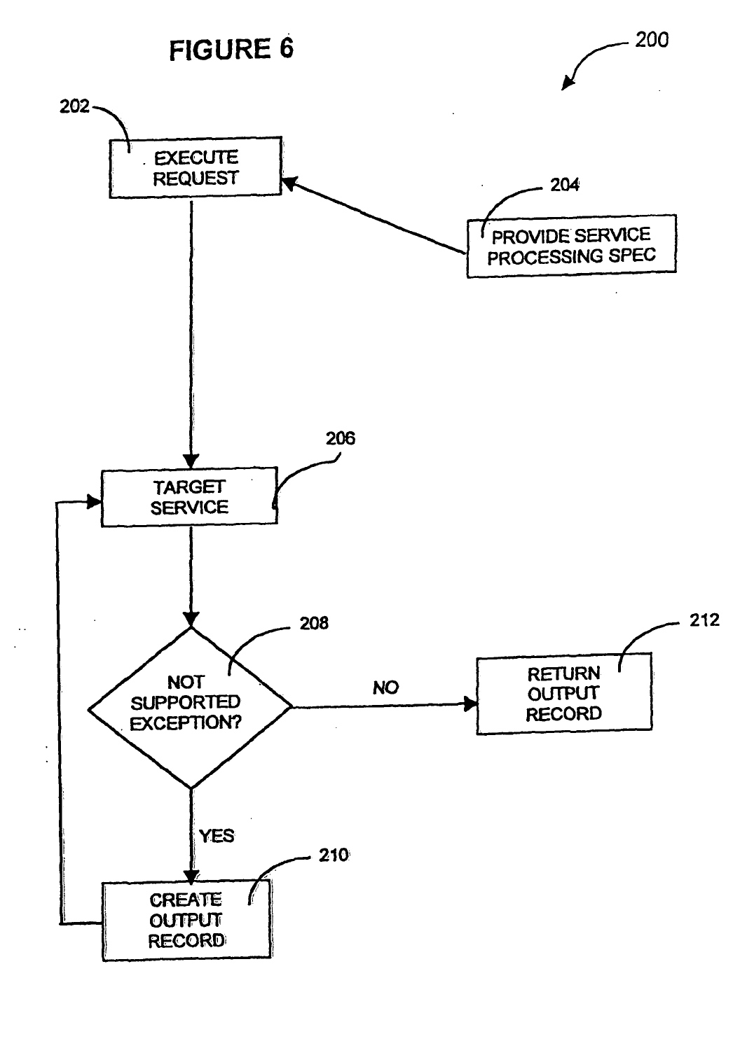

Referring now to FIG. 6, a flowchart illustrating the process of an inbound connector 32 to service a request is shown generally as 200. Beginning at step 202 ManagedService 88 obtains an instance of InteractionSpec from ManagedServiceProcessingSpec 87 at step 204. ManagedService 88 then calls the execute method of service 82 passing the instance of InteractionSpec as a parameter of execute. At step 206 the target service component 34 is selected. At step 208, a determination is made as to whether the application logic of the target service component 34 supports the invocation format of the execute method with input argument only. If there is a NotSupported exception, then at step 210 ManagedService 86 creates an OutputRecord and passes it to the execute method where processing returns to step 206. If there is no exception at step 208 then processing proceeds to step 212 where the results are obtained and returned to ManagedService 86.

In the particular scenarios shown in FIGS. 5 and 6, the stackability of connectors (see FIG. 3) has not been illustrated. The stackability of inbound connectors 32 means that the sequence illustrated in FIGS. 5 and 6 will be performed for each inbound connector 32 in the stack until all connectors 32 have completed processing.

Although the invention disclosed herein is described in the context of the J2EE Connector Architecture for Java, it will be appreciated by those skilled in the art that the invention is easily adaptable to other environments and programming languages, and that such adaptation would fall within the scope of the present invention as defined by the claims.

1. A computer system communicating with a communications network, said computer system comprising:
a) a component server providing services to one or more service components and one or more inbound connectors;
b) each of said service components providing application logic; and
c) said service components providing a set of interfaces to a plurality of computer systems, said set of interfaces independent of middleware hosted by said plurality of computer systems, said inbound connectors in communication with said communications network, said component server and said service components.

2. A computer system as claimed in claim 1 wherein said inbound connectors comprise:
a) a network interface for receiving a request from a computer system connected to said communications network;
b) a processing core, said processing core adapted to receive said request from said network interface and determine which of said one or more service components should handle said request; and
c) an interface in communication with said processing core and each of said one or more service components, by which said request is passed and by which a response is returned to said processing core, said processing core adapted to return said response to said computer system connected to said communications network.

3. A system as claimed in claim 2 wherein each of said inbound connectors may be replicated to provide a set of stacked inbound connectors.

4. A system as claimed in claim 3 wherein each inbound connector in. said set of stacked inbound connectors implements a different communication protocol than the inbound connector below it in said set of stacked inbound connectors.

5. A system as claimed in claim 4 wherein a base inbound connector at the base of said set of stacked inbound connectors communicates with one of said service components and receives said response from said one of said service components.

6. A system as claimed in claim 5 wherein said response is communicated from said base inbound connector to the next lowest inbound connector in said set of stacked connectors.

7. A method of establishing a service to communicate with a service component, said method comprising the steps of:
a) requesting said service;
b) if an instance of said service is available, utilizing said instance of said service; and
c) if an instance of said service is not available, creating an instance of said service.

8. A method as claimed in claim 7 further comprising the steps of:
d) obtaining an information specification;
e) invoking said service with said information specification as a parameter;
f) if an output record is record is required, creating said output record and returning to step b);
g) returning the results of step e).

9. A computer readable medium comprising instructions for enabling a computer system to communicate with a communications network, said medium comprising:
a) instructions for a component server to provide services to one or more service components and one or more inbound connectors;
b) each of said service components having instructions to provide application logic; and
c) said service components providing instruction to implement a set of interfaces to a plurality of computer systems , said set of interfaces independent of middleware hosted by said plurality of computer systems, said inbound connectors in communication with said communications network, said component server and said service components.

10. A medium as claimed in claim 9 wherein said inbound connectors comprise:
a) instructions for providing a network interface for receiving a request from a computer system connected to said communications network;
b) instructions for providing a processing core, said processing core adapted to receive said request from said network interface and determine which of said one or more service components should handle said request; and
c) instructions for providing an interface in communication with said processing core and each of said one or more service components, by which said request is passed and by which a response is returned to said processing core, said processing core adapted to return said response to said computer system connected to said communications network.

11. A medium as claimed in claim 10 further providing instructions to enable each of said inbound connectors to be replicated to provide a set of stacked inbound connectors.

12. A medium as claimed in claim 11 wherein each inbound connector in said set of stacked inbound connectors implements a different communication protocol than the inbound connector below it in said set of stacked inbound connectors.

13. A medium as claimed in claim 12 wherein a base inbound connector at the base of said set of stacked inbound connectors communicates with one of said service components and receives said response from said one of said service components.

14. A medium as claimed in claim 13 wherein said response is communicated from said base inbound connector to the next lowest inbound connector in said set of stacked connectors.
